(19) United States
(12) Patent Application Publication
(10) Pub. No.: US 2003/0095512 A1
(43) Pub. Date: May 22, 2003

(54) Microcell deployment strategies in WCDMA networks

(76) Inventor: Erol Hepsaydir, Berkshire (GB)

Correspondence Address: Vincent T. Pace, DANN, DORFMAN, HERRELL AND SKILLMAN, P.C., Suite 720, 1601 Market Street, Philadelphia, PA, 19103-2307, US

(21) Appl. No.: 10/294,446

(22) Filed: Nov. 14, 2002

(30) Foreign Application Priority Data
Nov. 16, 2001 (GB) 0127541.1

(51) Int. Cl. H04B 7/216

(52) U.S. Cl. 370/320; 370/335

(57) ABSTRACT

A WCDMA network using microcells and macrocells in which at least one frequency channel is shared by a microcell and a microcell within the macrocell. The shared frequency is allocated to calls whenever possible leaving an unshared frequency for use only if the shared frequency has insufficient capacity.

### BACKGROUND

The present invention relates to a mobile communications network. In such networks, a geographical area to be covered by the network is divided into cells each having a node. In existing networks the nodes are represented by base stations. Communications to and from a mobile terminal in a cell take place via a node over one or a number of frequency channels allocated to the cell. A base transmitter station (BTS) in a wideband code division multiple access network is referred to as a Node B.

Cells may be of different types. For example macrocells are used in a network to provide large area coverage. Currently, microcells are deployed in many networks to increase the capacity. Within one macrocell coverage area there maybe one or more microcells deployed as shown in FIG. 1.

In Wideband code division multiple access (WCDMA) networks, the macro and micro cell structure is used. A first group of frequency channels are allocated to the macrocells and a second group of different frequency channels are allocated to the microcells so that there is no overlap of channels between macro and micro cells. Each cell, i.e. microcell or macrocell, has its own Node B. Thus a caller within the geographical area of a microcell might be allocated to the microcell Node B or the macrocell Node B.

If adjacent cells have a common frequency channel, a terminal crossing the cell boundary will undergo what is called a “soft” handover from one channel to the other, i.e. the terminal continues to use the same frequency band. A handover which requires a change in frequency is called a “hard” handover.

According to the present invention as defined by claim 1, network coverage is improved by sharing frequency channels between macro and microcells, thereby enabling soft handovers to take place between macro and microcells.

Furthermore, it is advantageous to provide a minimum of two frequencies, one at the macrocell level and one at the microcell level, which are unshared.

The principals behind channel allocation are to ensure that:

1. enough capacity is reserved in hot spots where a significant number of users are located by sharing a frequency i.e. using frequency bands more efficiently;

2. there is always a less loaded frequency for the users to escape to when the UL (uplink) and DL (downlink) network quality of service deteriorates below the QoS (quality of service) requirements of the service; and

3. the use of Node B resources (e.g. Channel Elements) due to soft-handoff is optimised by handing off the user to another frequency.

Thus, another aspect of the invention provides a method of allocating frequencies in a system with micro and macrocells in which a shared frequency is used in preference to an unshared frequency. Typically a call will be allocated an unshared frequency only if the shared frequency or all available shared frequencies have insufficient capacity (e.g. they are already supporting too many customers) and/or cannot provide adequate quality of service.

Preferably a call using an unshared frequency will be moved to a shared frequency as soon as a shared frequency becomes available.

It will be appreciated that a “call” could be any kind of communication, not necessarily a voice call.

In the following some algorithms will also be discussed to increase the capacity in the network and to reduce the soft handoff area.

An embodiment of the invention will now be described by way of example only and with reference to the accompanying drawings in which:

FIG. 1 illustrates the deployment of a microcell within a macrocell, and includes a graph of their respective signal levels;

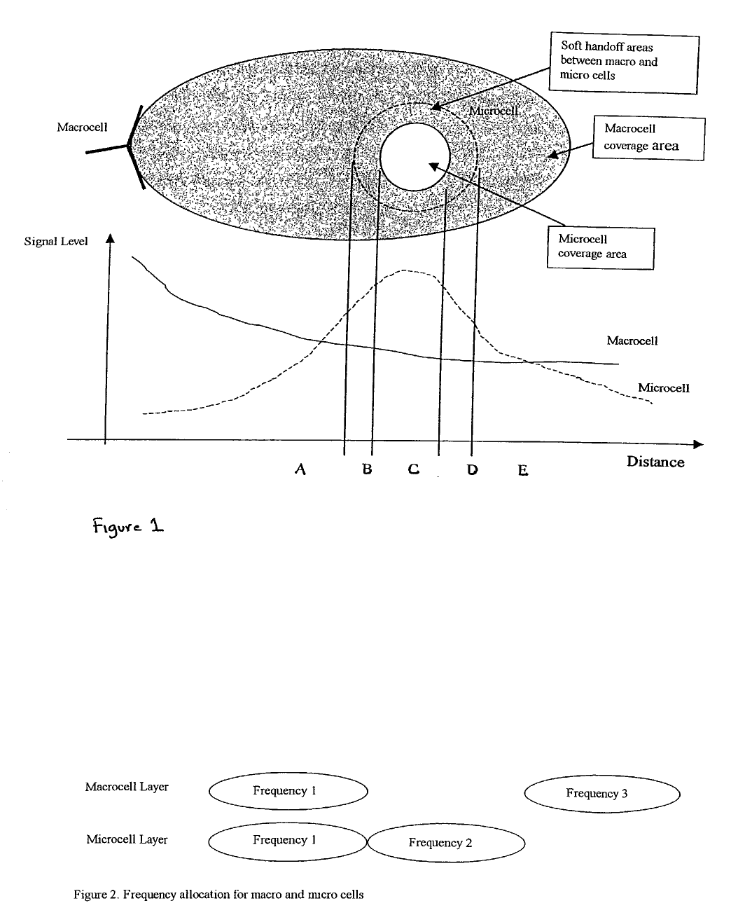

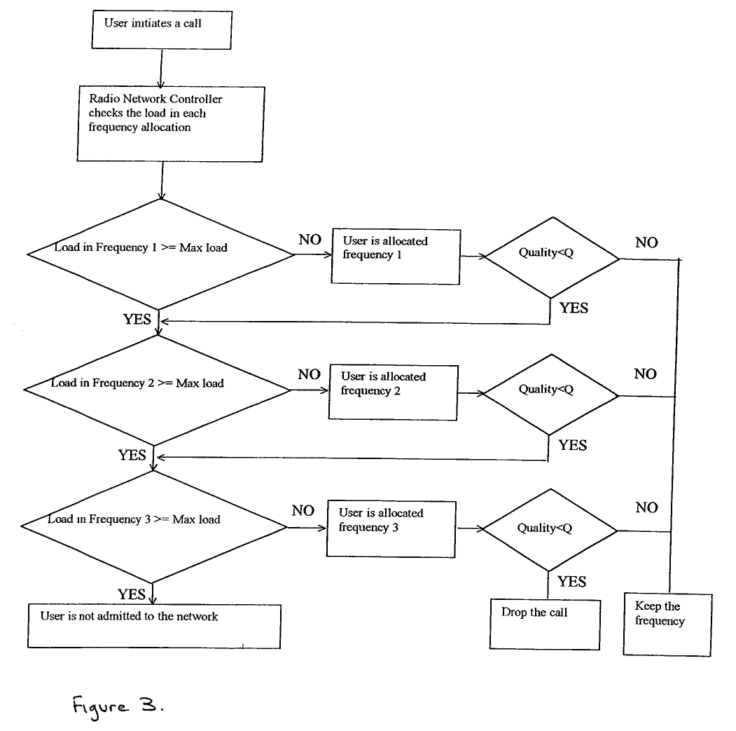

FIG. 2 illustrates the allocation of frequency channels between macro and microcells in an embodiment of the invention; and

FIG. 3 is a flow chart illustrating a possible frequency allocation algorithm.

Let us assume that 3 frequency division duplex (FDD) frequencies are to be used to operate a WCDMA network.

The network will be divided into macrocells, and microcells. The coverage area of one macrocell is shown shaded in grey and the white circle within it represents the coverage area of a microcell. The dotted line represents the soft handoff area between macro and microcell. The microcells will be deployed in hot spots. The frequency allocation of microcells and the macrocells will be as shown in FIG. 2.

As seen in FIG. 2, there are a minimum of two frequencies 2 and 3 not shared in macro and micro layers. It is anticipated that firstly the shared frequency 1 will be utilised by the users. Then when the ‘frequency 1’ is loaded, the frequency 2 in the micro layer will be utilised. The ‘frequency 3’ will be kept to the end to make sure that the users can escape when they have quality issues in the ‘frequency 1’ and ‘frequency 2’.

The idea of the present invention is to assign a shared frequency and in the preferred embodiment a minimum of two frequencies, one in the micro layer and one in the macro layer unshared. FIG. 3 explains the algorithm followed when a user wants to access the network. Users will be allocated one of the frequencies 1, 2, 3 according to the steps of the flowchart of FIG. 3.

FIG. 3 is a call setup algorithm that will be used when a caller within the geographical coverage of a microcell wants to access the network. The radio network controller knows the load in each frequency which is directly proportional to the number of users on each frequency. As can be seen from the flow chart, the shared frequency 1 is used in preference to the unshared frequencies 2 and 3. If frequency 1 is not available, the caller will be allocated to frequency 2 via the microcell Node B, and if that frequency is not available the caller will be allocated to frequency 3 via the macrocell Node B.

Minimising the soft handoff area

Soft handoff is an essential feature that WCDMA network has to have. Soft handoff can be explained as follows. When the handset moves from one cell coverage area to the neighbouring cell's coverage area, the handset starts using both sites for the same call, until the new cell's signal level is much stronger that the old one. Then the user drops the old cell. Since the handset uses both cells simultaneously it means that it is utilising channel elements in both cells for the same call. This would reduce the available hardware capacity in the network. It is always desirable to minimise the soft handoff area to increase the available hardware capacity in the network.

As explained above, the ‘frequency 1’ is used in both macro and micro cell layers. It is possible that there will be a large number of users in soft handoff (SHO) between the macro and micro cells. The following algorithm is proposed to optimise the use of soft handoff between the macro and micro cells (Refer to FIG. 1).

1. Handset is in area A

2. Handset moves to area B.

3. The Ec/Io (Chip Energy to Total Interference in the cell) level of the microcell increases so that the handset reports the Ec/Io level of the new cell to the RNC (Radio Network Controller).

4. The Radio Network Controller checks the number of users in soft handoff between the macro and micro cells in ‘frequency 1’. If there are more than ‘K’ users i.e. the number of utilised Channel Elements in soft handoff or the required BTS power allocated to the SHO users is higher than the threshold, the user is forced to change the frequency to ‘frequency 2’.

5. The user moves to area C

6. The Radio Network Controller checks the load in the ‘frequency 1’ and if there is enough capacity in the ‘frequency 1’, the Radio network controller changes the frequency of the user back to ‘frequency 1’.

7. In area D, the Radio network controller repeats 4

8. When the user moves to region E, the handset uses the ‘frequency 1’ in the macro cell.

The foregoing procedure ensures that no more than a maximum number of users is in soft handoff by allocating users to other channels if the shared frequency is overloaded.

1. A code division multiple access (CDMA) mobile communications network in which a geographical area covered by the network is divided into macrocells and each macrocell has a node, whereby communications to and from a mobile terminal in a macrocell take place via the node over one or more of a number of frequency channels allocated to the macrocell, wherein at least one cell has a microcell defined within it having its own node and the microcell shares at least one frequency channel with its macrocell.

2. A code division multiple access (CDMA) mobile communications network as claimed in claim 1 in which the macrocell has at least one channel which is not shared with the microcell.

3. A code division multiple access (CDMA) mobile communications network as claimed in claim 1 in which the microcell has at least one channel which is not shared with the macrocell.

4. A method of allocating frequencies in a CDMA mobile communications network in which a geographical area covered by the network is divided into macrocells and each macrocell has a node, whereby communications to and from a mobile terminal in a macrocell take place via the node over one or more of a number of frequency channels allocated to the macrocell, wherein at least one cell has a microcell defined within it having its own node and the microcell shares at least one frequency channel with its macrocell, the method comprising allocating a shared frequency to a call in preference to an unshared frequency.

5. A method as claimed in claim 4 in which a call is allocated an unshared frequency only of the shared frequency or shared frequencies have insufficient capacity and/or cannot provide adequate quality of service.

6. A method as claimed in claim 4 wherein a call using an unshared frequency is moved to a shared frequency as soon as a shared frequency becomes available.
